(19) United States
(12) Patent Application Publication
(10) Pub. No.: US 2003/0107903 A1
(43) Pub. Date: Jun. 12, 2003

(54) Brake NOW! - a helmet mounted safety brake light

(76) Inventor: John Grant Melton, Bend, OR (US)

Correspondence Address: JOHN G. MELTON, 3040 NE FAIRMONT CT., BEND, OR, 97701, US

(21) Appl. No.: 10/012,087

(22) Filed: Dec. 11, 2001

(51) Int. Cl. F21L 4/00

(52) U.S. Cl. 362/570

(57) ABSTRACT

Simply stated, the Brake NOW! helmet mounted brake light represents a breakthrough in rider safety by effectively alerting drivers behind them of their intentions to slow down or stop. The simple concept of putting a highly visible LED brake light directly on the rider's helmet has never been addressed before.

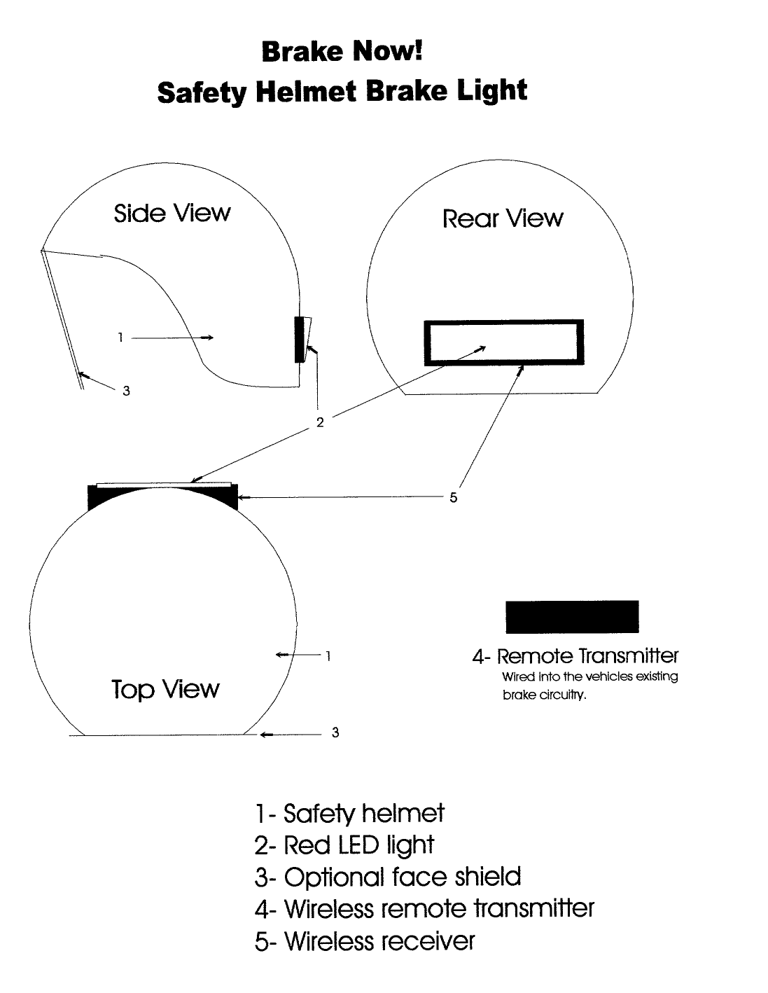

New laws have been passed requiring helmets to be worn while riding on public streets. Helmet manufacturers have gone to great lengths to make their product more impact resistant. They have also added unique paint and color schemes to make their helmets more visible. Nothing, however, comes close to the degree of safety that the Brake NOW! warning light affords.

Working exactly on the same theory that now makes it mandatory for automobile manufacturers to have a higher mounted, “3^{rd}” brake light in every car and truck—the Brake NOW! helmet mounted brake light accomplishes the same recognizable effect. Being seen equates to being safer!

### FIELD OF INVENTION

Traffic safety is a major concern to all motorists, and especially those who drive the two-wheeled variety. Currently, there is no prior art or technology that addresses the safety aspect of mounting a highly visible brake light to the back of a safety helmet.

### DESCRIPTION

The most visible part of a riders body and/or apparel is the safety helmet, it stands to reason that the most logical place to put a brake light is mounted directly on the back of the safety helmet. There is now a Federal Law in 47 States that require anyone who operates a motorized vehicle on public streets or property to wear a safety helmet. It has been conclusively proven that wearing a safety helmet reduces the occurrence of serious injury. And although constant improvements and government regulations have resulted in making safety helmets more impact resistant, my invention goes one step further by adding a highly visible brake light on the back of the helmet.

### DESCRIPTION OF THE PREFERRED EMBODIMENT

The Brake NOW! helmet mounted safety light consists of a wireless transmitter and a waterproof, helmet mounted receiver which activates an integral LED brake light. The device works as follows:

A wireless transmitter (element #4) is wired directly into the vehicles brake light system. When the brakes are applied, the circuit closes which activates the transmitter (element #4) and instantly sends a signal to the helmet mounted receiver (element #5) to power the LED light (element #2) to go “on”. This LED light alerts the drivers behind of their intentions to slow or stop. When the brakes are released, the circuit opens and the brake lights go out. This is a very simple design concept. It will effectively add another measure of protection to all riders who are required to wear safety helmets (element #1).

I believe it is entirely possible that when the general public and riding population see the safety advantages of my invention that new legislation will be introduced to make it mandatory for helmet wearers to wear helmets with the Brake NOW! safety light system.

I have enclosed 1 (one) page of drawings to illustrate my design and have 5 (five) elements listed on the bottom legend to help describe the relative size and location of each named element.

What I claim as my invention titled Brake Now! is the following:

1. Visibility is the key to reducing accidents:
I claim that my invention will alert other motorists of the Brake NOW! helmeted wearers' intentions and will significantly reduce the number of rear end accidents.
I claim that nothing currently exists that addresses the fact that a (motorcycle) riders helmet is the most visible part of his anatomy, and therefore, the best and most logical place to put a highly visible brake light.
The Brake NOW! system works exactly like a “3^{rd}” brake light in an automobile, and will make every rider equipped with this device substantially more visible. LED lights are inherently brighter than conventional bulb lights—so they can be seen faster, and from much further distances.

2. Safer riding for other outdoor enthusiasts:
I claim that all persons who ride motorized vehicles will be safer wearing a helmet equipped with a Brake NOW! device. Other rider applications may include:
1. All terrain vehicles (ATV or “Quad-Runners”)
2. Snowmobiles
3. Professional racers
